(19) United States
(12) Patent Application Publication
(10) Pub. No.: US 2026/0235264 A1
(43) Pub. Date: Aug. 13, 2026

(54) METHODS AND INTERNET OF THINGS SYSTEMS FOR ANTI-FREEZING MANAGEMENT OF SMART GAS PIPELINE NETWORK AND MEDIA

(71) Applicant: CHENGDU QINCHUAN IOT TECHNOLOGY CO., LTD., Chengdu (CN)

(72) Inventors: Zehua SHAO, Chengdu (CN); Yuefei WU, Chengdu (CN); Lei HE, Chengdu (CN)

(73) Assignee: CHENGDU QINCHUAN IOT TECHNOLOGY CO., LTD., Chengdu (CN)

(21) Appl. No.: 19/636,904

(22) Filed: Apr. 1, 2026

(30) Foreign Application Priority Data
Feb. 25, 2026 (CN) 202610221840.3

(51) Int. Cl. F17D 3/12; G16Y 40/10; G16Y 40/40; G16Y 40/50

(52) U.S. Cl. CPC F17D 3/12; G16Y 40/10; G16Y 40/40; G16Y 40/50

(57) ABSTRACT

Disclosed is a method and IoT system for anti-freezing operation of a smart gas pipeline network and a medium. The method is implemented by a smart gas company management platform of the IoT system for anti-freezing operation of the smart gas pipeline network, comprising: determining historical deposition data of a pipeline region based on historical pigging data; generating a first impact curve of the pipeline region based on the historical deposition data and historical maintenance data; determining a deposition impact value of the pipeline region based on current deposition data and the first impact curve; when the deposition impact value exceeds a first preset threshold, generating an antifreeze injection parameter based on current transmission data and planned transportation data of the pipeline region; and sending the antifreeze injection parameter to a smart gas equipment object platform, to control an antifreeze injection device to inject an antifreeze into a corresponding pipeline.

### CROSS-REFERENCE TO RELATED APPLICATIONS

This application claims priority to Chinese Application No. 202610221840.3, filed on February 25, 2026, the entire contents of which are incorporated herein by reference.

### TECHNICAL FIELD

The present disclosure generally relates to the field of natural gas transmission technology, and in particular to a method and Internet of Things (IoT) system for anti-freezing operation of a smart gas pipeline network and a medium.

### BACKGROUND

Hydrates may deposit inside a gas transmission pipeline. The hydrates may turn into a solid state at a low temperature, which may cause pipeline freezing and blockage, thus affecting normal gas transmission. Currently, adding an antifreeze into the pipeline can effectively reduce the impact caused by hydrate freezing. However, how to determine appropriate antifreeze injection parameters and injection regions is a problem to be solved.

Therefore, a method and Internet of Things (IoT) system for anti-freezing operation of a smart gas pipeline network and a medium are provided, which can effectively reduce the impact caused by hydrate freezing inside the gas pipeline, thereby improving gas transmission efficiency, and reducing energy consumption.

### SUMMARY

One or more embodiments of the present disclosure provide a method for anti-freezing operation of a smart gas pipeline network. The method comprises: obtaining, from a data center, historical pigging data of one or more pipeline regions in a target gas pipeline network, and determining historical deposition data of the one or more pipeline regions based on the historical pigging data; obtaining, from the data center, historical maintenance data of the one or more pipeline regions;generating a first impact curve of the one or more pipeline regions based on the historical deposition data and the historical maintenance data; at each preset period: determining a deposition impact value of the one or more pipeline regions based on current deposition data of the one or more pipeline regions and the first impact curve; in response to the deposition impact value of the one or more pipeline regions exceeding a first preset threshold, generating an antifreeze injection parameter based on current transmission data and planned transmission data of the one or more pipeline regions; and sending the antifreeze injection parameter to a smart gas equipment object platform to control, based on the antifreeze injection parameter, one or more antifreeze injection devices within the smart gas equipment object platform to inject an antifreeze into a corresponding pipeline.

One or more embodiments of the present disclosure provide an Internet of Things (IoT) system for anti-freezing operation of a smart gas pipeline network. The IoT system comprises a smart gas company management platform, a smart gas company sensor network platform, and a smart gas equipment object platform. The smart gas company management platform includes a data center. The smart gas company management platform is in communication with the smart gas equipment object platform through the smart gas company sensor network platform. The smart gas company management platform is configured to implement the method for the anti-freezing operation of the smart gas pipeline network.

One or more embodiments of the present disclosure provide a non-transitory computer-readable storage medium, comprising computer instructions that, when read by a computer, direct the computer to implement the method for the anti-freezing operation of the smart gas pipeline network described above.

### BRIEF DESCRIPTION OF THE DRAWINGS

The present disclosure is further described in an exemplary manner by embodiments, which are described in detail with reference to the accompanying drawings. These embodiments are not limiting. In these embodiments, the same reference numerals denote the same structures, wherein:

FIG. 1 is a schematic diagram illustrating a platform structure of an Internet of Things (IoT) system for anti-freezing operation of a smart gas pipeline network according to some embodiments of the present disclosure;

FIG. 2 is a flowchart illustrating an exemplary method for anti-freezing operation of a smart gas pipeline network according to some embodiments of the present disclosure;

FIG. 3 is a flowchart illustrating an exemplary process for determining a deposition impact value according to some embodiments of the present disclosure;

FIG. 4 is a schematic diagram illustrating an exemplary process for determining a target antifreeze injection device in one or more pipeline regions according to some embodiments of the present disclosure.

### DETAILED DESCRIPTION

To more clearly illustrate the technical solutions in the embodiments of the present disclosure, the accompanying drawings used in the description of the embodiments are briefly introduced below. It is obvious that the drawings in the following description are merely some examples or embodiments of the present disclosure. For a person of ordinary skill in the art, the present disclosure may be applied to other similar scenarios according to these drawings without creative efforts. Unless obviously obtained from the context or the context illustrates otherwise, the same numeral in the drawings refers to the same structure or operation.

It should be understood that the terms “system,” “apparatus,” “unit,” and/or “module” used herein are a method for distinguishing different components, elements, parts, sections, or assemblies at different levels. However, if other words may achieve the same purpose, the words may be replaced by other expressions.

As shown in the present disclosure and the claims, unless the context clearly indicates an exception, the words “a,” “an,” “one,” and/or “the” are not limited to the singular form, and may also include the plural form. Generally, the terms “comprising” and “including” only indicate inclusion of explicitly identified steps and elements. The steps and elements do not constitute an exclusive list. The method or apparatus may also include other steps or elements.

Flowcharts are used in the present disclosure to illustrate operations performed by the system according to the embodiments of the present disclosure. It should be understood that preceding or following operations are not necessarily performed precisely in order. On the contrary, each step may be processed in reverse order or simultaneously. At the same time, other operations may be added to the processes, or one or more steps may be removed from the processes.

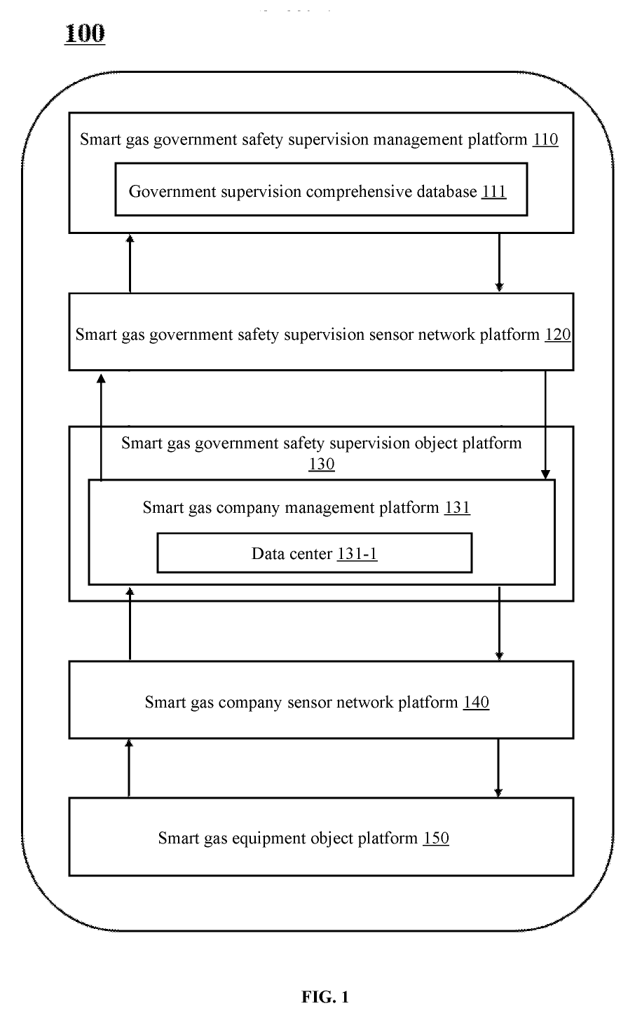

FIG. 1 is a schematic diagram illustrating a platform structure of an Internet of Things (IoT) system for anti-freezing operation of a smart gas pipeline network according to some embodiments of the present disclosure.

In some embodiments, as shown in FIG. 1, an IoT system 100 for anti-freezing operation of a smart gas pipeline network includes a smart gas government safety supervision management platform 110, a smart gas government safety supervision sensor network platform 120, a smart gas government safety supervision object platform 130, a smart gas company sensor network platform 140, and a smart gas equipment object platform 150.

The smart gas government safety supervision management platform refers to a management platform for a government to process and supervise safety-related information.

In some embodiments, the smart gas government safety supervision management platform includes a government supervision comprehensive database 111.

The government supervision comprehensive database refers to a system for a government to comprehensively manage and store data.

The smart gas government safety supervision sensor network platform refers to a management platform for supervising government safety-related sensing information. In some embodiments, the smart gas government safety supervision sensor network platform is configured as a communication network or a gateway, etc., and may implement functions of sensing communication for perception information and sensing communication for control information.

In some embodiments, the smart gas government safety supervision sensor network platform interacts upward with the smart gas government safety supervision management platform and interacts downward with a smart gas company management platform of the smart gas government safety supervision object platform.

The smart gas government safety supervision object platform refers to a platform for a government to supervise generation of safety information and execution of control information. In some embodiments, the smart gas government safety supervision object platform includes a smart gas company management platform 131.

The smart gas company management platform refers to a comprehensive management platform for gas company information.

In some embodiments, the smart gas company management platform is configured to process and store data of the IoT system for the anti-freezing operation of the smart gas pipeline network.

In some embodiments, the smart gas company management platform is configured as a server or a terminal used internally by a gas company. The server or the terminal may process data and/or information obtained from other platforms. The server may execute program instructions based on the data, the information, and/or processing results to perform one or more functions described in the present disclosure.

In some embodiments, the smart gas company management platform includes a data center 131-1.

The data center refers to a storage device used internally by a gas company for storing gas company information.

The smart gas company sensor network platform refers to a platform for managing information communication between the smart gas company management platform and the smart gas equipment object platform. In some embodiments, the smart gas company sensor network platform is configured as a communication network or a gateway, etc.

In some embodiments, the smart gas company sensor network platform performs data interaction upward with the smart gas company management platform and performs data interaction downward with the smart gas equipment object platform.

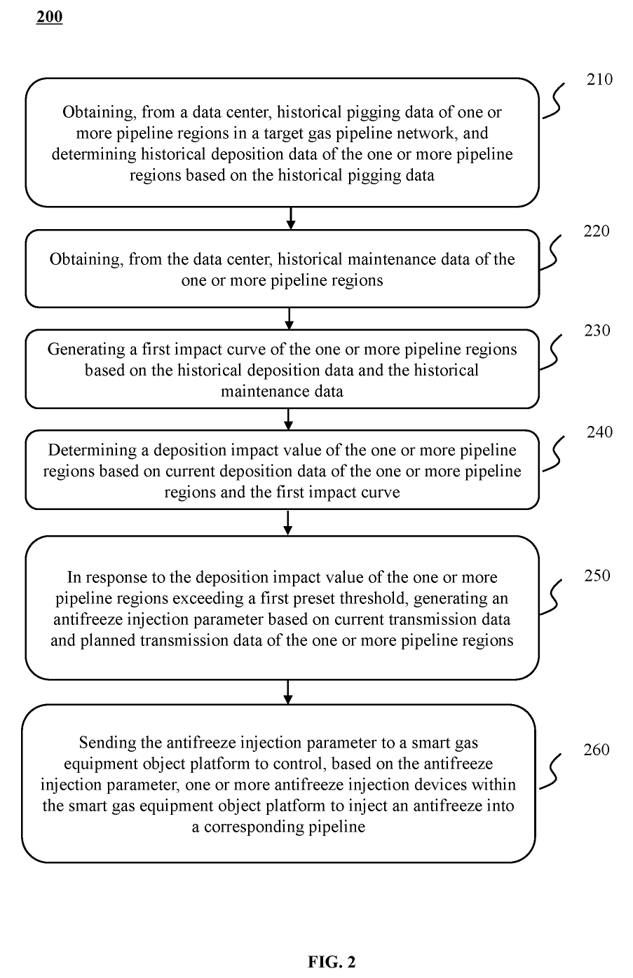

The smart gas equipment object platform refers to a functional platform for generation of perception information and execution of control information. In some embodiments, the smart gas equipment object platform includes sensors disposed on a gas pipeline, one or more antifreeze injection devices, and a heating device. More descriptions regarding the one or more antifreeze injection devices may be found in operation 260 of FIG. 2 and the related descriptions thereof.

The sensors refer to devices that receive and convert various measurement information. For example, the sensors may include a temperature sensor, a pressure sensor, a flow sensor, an ultrasonic sensor, or the like.

The heating device refers to a device for heating and raising a temperature inside a pipeline. In some embodiments, the heating device is disposed on an outer wall of the pipeline. The heating device may heat the pipeline.

More descriptions regarding the IoT system for the anti-freezing operation of the smart gas pipeline network and the method for the anti-freezing operation of the smart gas pipeline network may be found in FIG. 2 to FIG. 4 and the related descriptions thereof.

In some embodiments of the present disclosure, the IoT system for the anti-freezing operation of the smart gas pipeline network may form an information operation closed loop among various functional platforms for coordinated and regular operation. The IoT system for anti-freezing operation of the smart gas pipeline network achieves accurate and efficient addition of the antifreeze, and reduces the impact caused by hydrate freezing in gas.

FIG. 2 is a flowchart illustrating an exemplary method for anti-freezing operation of a smart gas pipeline network according to some embodiments of the present disclosure. As shown in FIG. 2, a process 200 includes the following operaetions. In some embodiments, the process 200 may be executed by a smart gas company management platform (hereinafter referred to as a management platform).

In 210, obtaining, from a data center, historical pigging data of one or more pipeline regions in a target gas pipeline network, and determining historical deposition data of the one or more pipeline regions based on the historical pigging data.

The target gas pipeline network refers to a network composed of pipelines that need to be managed or analyzed. In some embodiments, the target gas pipeline network may be divided into a plurality of pipeline regions.

The pipeline region refers to a sub-region in the target gas pipeline network. In some embodiments, the pipeline region may include a plurality of pipes.

The historical pigging data refers to historical data related to pipeline cleaning. In some embodiments, the historical pigging data may include a historical time point of pipeline cleaning, a cleaned gas pipeline, and a volume of hydrates cleaned out.

The historical deposition data refers to historical data related to hydrate deposition. In some embodiments, the historical deposition data of the one or more pipeline regions may include a historical volume of hydrates cleaned out from the one or more pipeline regions, a gas pipeline where the hydrates were located, and a historical pigging time point corresponding to the hydrates.

In 220, obtaining, from the data center, historical maintenance data of the one or more pipeline regions.

The historical maintenance data refers to historical data related to pipeline maintenance. In some embodiments, the historical maintenance data may include a regulation lag duration corresponding to a pipeline before historical maintenance of the pipeline, a gas pressure, and a gas flow rate.

The regulation lag duration refers to a difference between an actual regulation duration and a reference regulation duration of a gas pressure at a downstream of the pipeline after regualting the gas pressure at an upstream of the pipeline. The actual regulation duration refers to an actual duration for regulating the gas pressure in the pipeline to a preset gas pressure. The reference regulation duration refers to an average duration for regulating the gas pressure to the preset gas pressure during a plurality of historical regulations of the pipeline. The preset gas pressure may be set by a person skilled in the art based on experience. Preset gas pressures corresponding to a plurality of pipelines may be the same or different.

In 230, generating a first impact curve of the one or more pipeline regions based on the historical deposition data and the historical maintenance data.

The first impact curve is used to reflect an impact of a hydrate volume in each pipeline within the one or more pipeline regions on gas transmission. In some embodiments, one pipe may correspond to one first impact curve.

In some embodiments, the first impact curve may be represented by two-dimensional coordinates, where an abscissa represents the hydrate volume in pipeline, and an ordinate represents a deposition impact value of the pipeline. The deposition impact value is used to reflect an impact degree of hydrates in the pipeline on gas transportation.

In some embodiments, the management platform may perform operations 240 to 260 for each preset period. The preset period may be set by a person skilled in the art based on experience. For example, the preset period may be one week or one month, etc.

In 240, determining a deposition impact value of the one or more pipeline regions based on current deposition data of the one or more pipeline regions and the first impact curve.

The current deposition data refers to data related to current hydrate deposition. In some embodiments, the current deposition data includes a current hydrate volume in each pipeline of the one or more pipeline regions. In some embodiments, an ultrasonic sensor disposed on the pipeline may measure a pipeline wall thickness, and then infer the current hydrate volume in the pipeline.

In some embodiments, the management platform may determine a deposition impact value corresponding to the current hydrate volume through a first impact curve of each pipeline based on the current hydrate volume in each pipeline of the one or more pipeline regions, calculate an average of the deposition impact values of the pipelines, and use the average as the deposition impact value of the one or more pipeline regions.

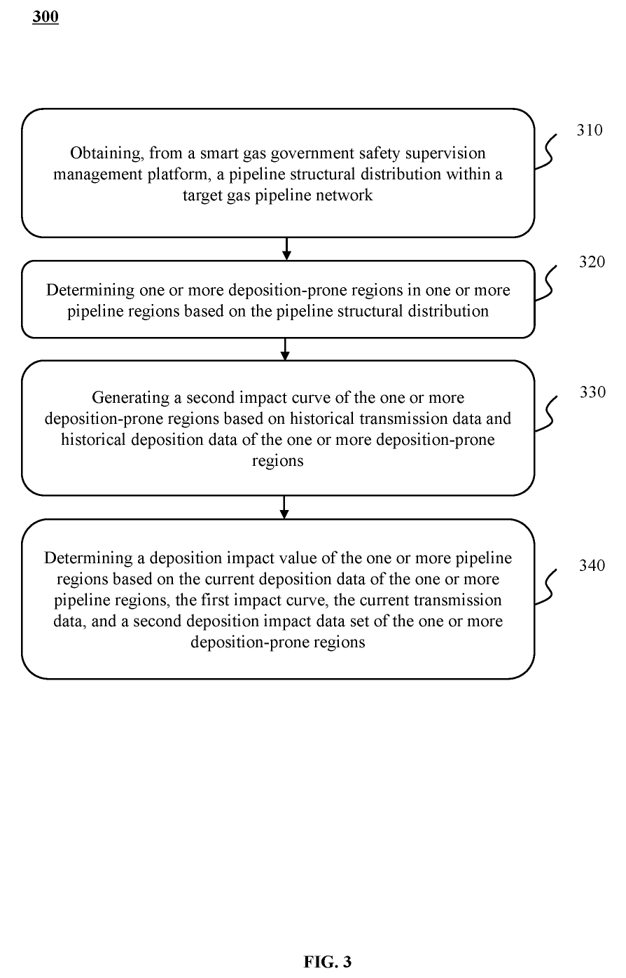

In some embodiments, the management platform may determine the deposition impact value of the one or more pipeline regions based on the current deposition data of the one or more pipeline regions, the first impact curve, current transmission data, and a second deposition impact data set of one or more deposition-prone regions. More descriptions regarding this part may be found in FIG. 3 and the related descriptions thereof.

In 250, in response to the deposition impact value of the one or more pipeline regions exceeding a first preset threshold, generating an antifreeze injection parameter based on current transmission data and planned transmission data of the one or more pipeline regions.

In some embodiments, the first preset threshold may be positively correlated to a layout density of one or more antifreeze injection devices in the one or more pipeline regions, or the first preset threshold may be set by a person skilled in the art based on experience.

It is understood that a smaller layout density of the one or more antifreeze injection devices indicates a worse capability to clear hydrates in the one or more pipeline regions, and thus a smaller first preset threshold needs to be set to ensure that the hydrate volume is within the clearing capability of the one or more antifreeze injection devices.

Descriptions regarding the one or more antifreeze injection devices and the layout density may be found in the related descriptions of operation 260.

The current transmission data refers to data related to current gas transmission. In some embodiments, the current transmission data may include a current gas pressure and a current gas flow rate.

The planned transmission data refers to data related to planned gas transmission. In some embodiments, the planned transmission data may include a gas transmission time period.

The antifreeze injection parameter refers to a parameter related to antifreeze injection. In some embodiments, the antifreeze injection parameter may include an injection time period, an injection speed, and an injection pressure of the antifreeze.

In some embodiments, the management platform may determine a time period when gas passes through a pipeline port for antifreeze injection based on the gas transmission time period, and use the time period as an injection time period of the antifreeze, to inject the antifreeze into the gas when the gas passes through the pipeline port. The management platform may use the current gas pressure as the injection pressure of the antifreeze.

In some embodiments, the management platform may determine a reference gas flow rate and a reference gas pressure that are the same as or closest to the current gas flow rate and the current gas pressure by querying a first preset table based on the current gas flow rate and the current gas pressure, and determine a reference injection speed of the antifreeze corresponding to the reference gas flow rate and the reference gas pressure as the injection speed of the antifreeze.

The first preset table may be constructed based on experiments. The first preset table may include a plurality of reference gas flow rates and reference gas pressures, and corresponding reference injection speeds of the antifreeze.

In 260, sending the antifreeze injection parameter to a smart gas equipment object platform to control, based on the antifreeze injection parameter, one or more antifreeze injection devices within the smart gas equipment object platform to inject an antifreeze into a corresponding pipeline.

In some embodiments, each of the one or more antifreeze injection devices may include a mobile storage tank, a suction pipeline, a plunger pump, and an injection pipeline.

The mobile storage tank refers to a movable antifreeze storage tank.

The suction pipeline is configured to control opening and closing of a valve at an end of the suction pipeline connected to the mobile storage tank based on the injection time period of the antifreeze, to transport the antifreeze from the mobile storage tank to the plunger pump. In some embodiments, two ends of the suction pipeline are connected to the mobile storage tank and the plunger pump, respectively.

The plunger pump is configured to pressurize the antifreeze based on the injection pressure, and extrude the antifreeze based on the injection speed. In some embodiments, the injection speed of the antifreeze may be controlled by adjusting an operation parameter of the plunger pump.

The injection pipe is configured to inject the antifreeze extruded by the plunger pump into the pipeline through the pipeline port. In some embodiments, two ends of the injection pipeline are connected to the plunger pump and the pipeline port, respectively.

The pipeline port refers to an interface through which the one or more antifreeze injection devices inject the antifreeze into a gas pipeline. In some embodiments, the pipeline port may be a pipeline port reserved at a gas valve, a pressure gauge interface of a pipeline, or the like.

In some embodiments, the antifreeze may include methanol, or the like.

In some embodiments, when the one or more antifreeze injection devices inject the antifreeze into the pipeline, the antifreeze in the mobile storage tank enters the plunger pump through the suction pipeline, the plunger pump increases a pressure of the antifreeze to a required injection pressure, and then injects the antifreeze into the pipeline through the injection pipeline.

In some embodiments, the smart gas equipment object platform further includes a heating device disposed on a gas pipeline. The management platform is further configured to: determine a layout density of the one or more antifreeze injection devices of the one or more pipeline regions based on the historical pigging data and the historical maintenance data of the one or more pipeline regions; determine a regulation region based on the layout density; generate a heating regulation parameter based on the planned transmission data of the one or more regulation regions; and control, based on the heating regulation parameter, the heating device disposed in the regulation region to operate to heat a pipeline in the regulation region to a target temperature.

The heating device refers to a device disposed on an outer wall of a pipeline and configured to heat the gas pipeline.

In some examples, the management platform may determine a maintenance frequency of the one or more pipeline regions and an average of deposition impact values corresponding to hydrate volumes during a plurality of pigging operations based on the historical pigging data and the historical maintenance data of the one or more pipeline regions. The management platform may query a second preset table to obtain a reference layout density corresponding to a reference maintenance frequency and a reference deposition impact value closest to the maintenance frequency and the average of the deposition impact values, and use the reference layout density as a layout density of the one or more antifreeze injection devices of the one or more pipeline regions.

The second preset table may be constructed based on historical data. The second preset table may include a plurality of reference maintenance frequencies and reference deposition impact values of reference pipeline regions, and corresponding reference layout densities.

The regulation region refers to a pipeline region that does not satisfy the layout density.

The heating regulation parameter refers to a regulation parameter of the heating device. In some embodiments, the heating regulation parameter may include a heating time period of the heating device and a target temperature.

In some embodiments, the management platform may use the gas transmission time period as the heating time period based on the planned transmission data. The target temperature may be a preset temperature that needs to be reached during gas transmission. The target temperature may be set by a person skilled in the art based on experience.

In some embodiments, the management platform may control the heating device to heat the pipeline to the target temperature within the heating time period.

In some embodiments of the present disclosure, when a count of pipeline ports connected to the one or more antifreeze injection devices is insufficient, a dredging effect of the antifreeze on the entire pipeline regions is limited. Accordingly, regulating parameters of the heating device based on a distribution of the pipeline ports may regulate a temperature of gas within the pipeline, thereby preventing formation of hydrates.

In some embodiments of the present disclosure, valve opening/closing nodes and antifreeze injection amounts of the one or more antifreeze injection devices are regulated based on impact values of hydrates in different pipeline regions, thereby reducing generation of hydrates and improving gas transmission efficiency.

FIG. 3 is a flowchart illustrating an exemplary process for determining a deposition impact value according to some embodiments of the present disclosure. As shown in FIG. 3, a process 300 includes the following operaetions. In some embodiments, the process 300 may be executed by the management platform.

In 310, obtaining, from a smart gas government safety supervision management platform, a pipeline structural distribution within a target gas pipeline network.

The pipeline structural distribution is used to characterize a structural distribution of pipelines. In some embodiments, the pipeline structural distribution may include a pipeline vertical inclination angle and a pipeline bending angle. The pipeline vertical inclination angle and the pipeline bending angle refer to an angle of a pipeline axis and an angle of a tangent at a pipeline bend with respect to a horizontal plane, respectively.

In 320, determining one or more deposition-prone regions in one or more pipeline regions based on the pipeline structural distribution.

The deposition-prone region refers to a region where hydrate deposition per unit time is greater than a deposition threshold. The unit time and the deposition threshold may be set by a person skilled in the art based on experience.

In some embodiments, the management platform may determine a region within the one or more pipeline regions where a weighted sum of the pipeline vertical inclination angle and the pipeline bending angle is greater than a second preset threshold as the deposition-prone region. Weights and the second preset threshold may be set by a person skilled in the art based on experience.

In some embodiments, the second preset threshold is negatively correlated with a gas transmission frequency of the pipeline. Second preset thresholds corresponding to a plurality of pipelines may be the same or different. The gas transmission frequency refers to a count of times gas transmission is performed by the pipeline within a preset period. The gas transmission frequency may be determined based on historical data. The preset period may be set by a person skilled in the art based on experience.

It is understood that even the pipeline vertical inclination angle and/or the pipeline bending angle of a pipeline is small, a possibility of hydrate deposition in the pipeline is relatively high when the gas transmission frequency of the pipeline is high. Therefore, the second preset threshold corresponding to the pipeline needs to be reduced.

In some embodiments, the smart gas equipment object platform further includes one or more monitoring devices. The management platform is further configured to: in response to a change of the one or more deposition-prone regions, generate a first regulation instruction and a second regulation instruction, and send the first regulation instruction and the second regulation instruction to the smart gas equipment object platform, to cause the one or more monitoring devices disposed in the one or more deposition-prone regions to perform gas data monitoring and gas data upload based on a first monitoring frequency and a first upload frequency in the first regulation instruction; and cause one or more monitoring devices disposed in one or more non-deposition-prone regions to perform gas data monitoring and gas data upload based on a second monitoring frequency and a second upload frequency in the second regulation instruction.

It is understood that when a path of gas transmission changes, gas transmission frequencies of some pipeline regions decrease, and gas transmission frequencies of other pipeline regions increase. Hydrate deposition is positively correlated with the gas transmission frequency. Therefore, the one or more deposition-prone regions change.

The one or more monitoring devices are configured to monitor the one or more pipeline regions. In some embodiments, the one or more monitoring device may monitor gas data of the one or more pipeline regions. The gas data refers to data related to gas. For example, the gas data may include a gas flow rate, a gas pressure, the gas transmission frequency, etc.

In some embodiments, the one or more monitoring devices may send monitored gas data of the one or more deposition-prone regions and the one or more non-deposition-prone regions to the management platform. The management platform may determine a change of the one or more deposition-prone regions based on the gas data. For example, the management platform may update a region where the gas transmission frequency is greater than a transmission frequency threshold as the deposition-prone region and update a region where the gas transmission frequency is less than the transmission frequency threshold as the non-deposition-prone region based on gas transmission frequencies of the one or more deposition-prone regions and the one or more non-deposition-prone regions. The management platform may generate and issue the first regulation instruction and the second regulation instruction to the one or more monitoring devices.

The first regulation instruction and the second regulation instruction refer to instructions for monitoring the deposition-prone region and the non-deposition-prone region, respectively. The non-deposition-prone region refers to a region where hydrate deposition per unit time is less than the deposition threshold.

In some embodiments, the first regulation instruction may include the first monitoring frequency and the first upload frequency. The second regulation instruction may include the second monitoring frequency and the second upload frequency.

The first monitoring frequency and the first upload frequency refer to frequencies for monitoring and uploading gas data of the deposition-prone region, respectively. The second monitoring frequency and the second upload frequency refer to frequencies for monitoring and uploading gas data of the non-deposition-prone region, respectively. In some embodiments, the first monitoring frequency and the first upload frequency are greater than the second monitoring frequency and the second upload frequency, respectively.

In some embodiments, the management platform may increase an initial monitoring frequency and an initial upload frequency by a preset adjustment amount, respectively, to obtain the first monitoring frequency and the first upload frequency, respectively, thereby generating the first regulation instruction.

In some embodiments, the management platform may use the initial monitoring frequency and the initial upload frequency as the second monitoring frequency and the second upload frequency, respectively, thereby generating the second regulation instruction.

The initial monitoring frequency, the initial upload frequency, and the preset adjustment amount may be set by a person skilled in the art based on experience. In some embodiments, the preset adjustment amount is positively correlated with a blockage risk of pipeline regions to which the one or more deposition-prone regions belong. The blockage risk refers to a risk of blockage occurring in the pipeline regions.

In some embodiments of the present disclosure, when a path of gas transportation changes, the one or more deposition-prone regions in the one or more pipeline regions also change. In this case, a monitoring frequency of a region that becomes a deposition-prone region may be appropriately increased, and a monitoring frequency of a region that becomes a non-deposition-prone region may be appropriately decreased, to improve accuracy of monitoring.

In 330, generating a second impact curve of the one or more deposition-prone regions based on historical transmission data and historical deposition data of the one or more deposition-prone regions.

The historical transmission data refers to historical data related to gas transmission. In some embodiments, the historical transmission data may include a historical transmission time period, and a historical gas flow rate and a historical gas pressure corresponding to the historical transmission time period.

The second impact curve refers to an impact of a hydrate volume on gas transportation under a certain gas flow rate range in the deposition-prone region. In some embodiments, one deposition-prone region may correspond to a plurality of second impact curves under a plurality of different gas flow rate ranges.

In some embodiments, the second impact curve may be represented by two-dimensional coordinates, where an abscissa represents a hydrate volume of a pipeline, and an ordinate represents a deposition impact value of the pipeline.

In some embodiments, the management platform may cluster the historical transmission data based on the historical gas flow rate to obtain a plurality of clusters. For the historical transmission data within each cluster and the historical deposition data of a same time period, a second impact curve corresponding to the cluster (i.e., under a corresponding gas flow rate range) may be generated. A process of generating the second impact curve is similar to the process of generating the first impact curve.

Through the above manner, a plurality of second impact curves corresponding to one deposition-prone region under a plurality of different historical gas flow rates may be obtained.

In 340, determining a deposition impact value of the one or more pipeline regions based on current deposition data of the one or more pipeline regions, a first impact curve, current transmission data, and a second deposition impact data set of the one or more deposition-prone regions.

The second deposition impact data set refers to a data set composed of a plurality of second impact curves of the deposition-prone region.

In some embodiments, for the deposition-prone region, the management platform may obtain, from the second deposition impact data set, a second impact curve corresponding to a historical gas flow rate closest to a current gas flow rate based on the current gas flow rate. The management platform may determine a deposition impact value of hydrates corresponding to the deposition-prone region through the second impact curve based on a current hydrate volume. More descriptions regarding the current gas flow rate and the current hydrate volume may be found in FIG. 2 and the related descriptions thereof.

In some embodiments, for the non-deposition-prone region, the management platform may determine a deposition impact value of hydrates corresponding to the non-deposition-prone region through a manner in the operation 240 of FIG. 2.

In some embodiments of the present disclosure, when the gas flow rate is small, gas inertia is small, and a gas flow direction is susceptible to disturbances such as bends. The gas flow direction changes abruptly in a region with many bends or a large vertical inclination angle, causing a throttling problem and thus forming hydrates. Therefore, the deposition impact value of hydrates is evaluated based on the gas flow rate and the pipeline structure, and antifreeze injection is regulated, thereby improving stability of gas transportation.

In some embodiments, the management platform is further configured to: determine a blockage risk of the one or more pipeline regions through a data processing model based on the current transmission data, the planned gas transmission data, and the current deposition data of the one or more pipeline regions, and the pipeline vertical inclination angle and the pipeline bending angle of the one or more deposition-prone regions; the data processing model being a machine learning model; generate a maintenance regulation instruction based on the blockage risk of the one or more pipeline regions, and send the maintenance regulation instruction to the smart gas equipment object platform; and control, based on the maintenance regulation instruction, an opening duration of an output valve at an antifreeze storage container of the one or more pipeline regions to store a target volume of antifreeze into a mobile storage tank, to perform allocation of pipeline maintenance materials among the one or more pipeline regions.

In some embodiments, the data processing model may be a recurrent neural network (RNN) model, a deep neural network (DNN) model, or the like.

In some embodiments, an input of the data processing model may include the current transmission data, the planned transmission data, and the current deposition data of the one or more pipeline regions, and the pipeline vertical inclination angle and the pipeline bending angle of the one or more deposition-prone regions. An output of the data processing model may include the blockage risk of the one or more pipeline regions.

More descriptions regarding the current transmission data, the planned transmission data, and the current deposition data may be found in FIG. 2 and the related descriptions thereof. More descriptions regarding the pipeline vertical inclination angle and the pipeline bending angle may be found in FIG. 3 and the related descriptions thereof.

In some embodiments, the data processing model may be obtained by training based on a plurality of first training samples with first labels. The first training samples include sample current transmission data, sample transportation data, and sample current deposition data of a sample pipeline region, and a sample pipeline vertical inclination angle and a sample pipeline bending angle of a sample deposition-prone region in a historical first time period. The first labels include a sample blockage risk of the sample pipeline region. The first training samples may be obtained through historical data. The first labels may be constructed based on a count of blockages of the sample pipeline region corresponding to the first training sample in a historical second time period. The historical first time period is earlier than the historical second time period.

In some embodiments, the plurality of first training samples with the first labels may be input into an initial data processing model. A loss function is constructed based on the first labels and a result of the initial data processing model. Parameters of the initial data processing model are iteratively updated based on the loss function through gradient descent or other approaches. A plurality of iterative trainings are performed through the above manner. When a preset condition is satisfied, model training is completed, and a trained data processing model is obtained. The preset condition may be convergence of the loss function, etc.

In some embodiments, the management platform is further configured to: when training the data processing model, multiply a learning rate of the data processing model by a decay factor after reaching a preset count of trainings; the preset count of trainings being determined based on a historical deposition impact value of each pipeline in the one or more pipeline regions.

In some embodiments, a value of the decay factor is between 0 and 1, and may be set by a person skilled in the art based on experience.

In some embodiments, after the preset count of trainins is reached, the data processing model may multiply a learning rate of a last training by the decay factor to obtain an updated learning rate. The updated learning rate is used for subsequent training to improve the convergence speed and performance of the data processing model.

In some embodiments, the preset count of trainings is positively correlated to an average of standard deviations of historical deposition impact values of each pipeline in the one or more pipeline regions. In some embodiments, a manner of obtaining the historical deposition impact values is the same as a manner of obtaining the deposition impact value based on the first deposition curve. More descriptions may be found in the operation 240 of FIG. 2 and the related descriptions thereof.

In some embodiments of the present disclosure, a larger standard deviation of historical deposition impact values of each pipeline indicates a greater difference in the impact of hydrate deposition on each pipeline. The learning rate of the data processing model is regulated based on the difference of the historical deposition impact values of each pipeline, so that the data processing model can better converge to an optimal solution, avoiding oscillation or failure to converge during the training process.

The maintenance regulation instruction refers to an instruction for maintaining and regulating a pipeline region where blockage occurs.

In some embodiments, the management platform may use a pipeline region with a blockage risk greater than a preset risk threshold as a risk region, generate the maintenance regulation instruction, and send the maintenance regulation instruction to the smart gas equipment object platform. The maintenance regulation instruction includes: if a current storage amount of an antifreeze in an antifreeze storage container of the risk region is less than a standard storage amount, preferentially allocate a target volume of antifreeze from a non-risk region closest to the risk region until the storage amount of the antifreeze in the risk region reaches the corresponding standard storage amount.

The non-risk region refers to a pipeline region with a blockage risk less than the preset risk threshold. The target volume refers to a difference between the standard storage amount of the antifreeze corresponding to the risk region and the current storage amount of the antifreeze in the antifreeze storage container. The preset risk threshold and the standard storage amount may be set by a person skilled in the art based on experience.

In some embodiments, at least one antifreeze storage container may be disposed in each pipeline region. The at least antifreeze storage container may be connected to at least one mobile storage tank through at least one delivery pipeline. An electric valve is disposed at an end of the at least delivery pipeline connected to the at least antifreeze storage container.

In some embodiments, the smart gas equipment object platform may obtain the target volume of antifreeze to be allocated based on the maintenance regulation instruction, to determine an opening duration and an opening degree of the electric valve.

In some embodiments of the present disclosure, allocation of the antifreeze is performed based on the blockage risk of the pipeline region, so that the possibility of blockage of the gas pipeline due to insufficient antifreeze can be reduced, further reducing the risk of gas transmission.

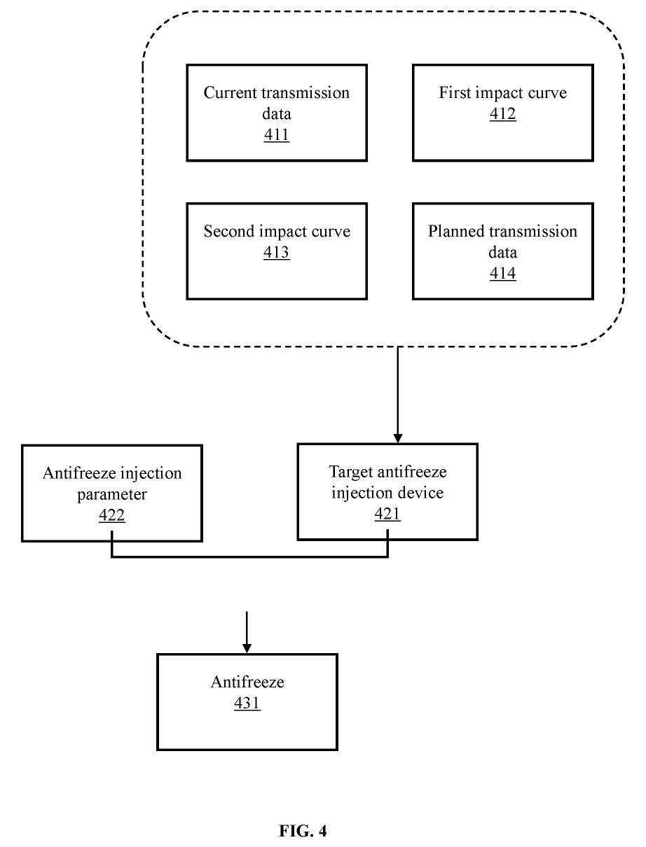

FIG. 4 is a schematic diagram illustrating an exemplary process for determining a target antifreeze injection device in one or more pipeline regions according to some embodiments of the present disclosure.

In some embodiments, as shown in FIG. 4, the smart gas company management platform determines a target antifreeze injection device 421 in the one or more pipeline regions based on current transmission data 411 of the one of more pipeline regions, a first impact curve 412, a second impact curve 413, and planned transportation data 414. The smart gas company management platform controls the target antifreeze injection device 421 to inject an antifreeze 431 into a corresponding pipeline based on an antifreeze injection parameter 422.

In some embodiments, more descriptions regarding the current transmission data, the planned transmission data, the first impact curve, the second impact curve, the antifreeze injection parameter, and the antifreeze may be found in the operation 230 and the operation 250 of FIG. 2, the operation 330 of FIG. 3, and the related descriptions thereof.

In some embodiments, a first impact threshold and a second impact threshold may be preset based on historical experience. The first impact threshold may be preset to be greater than the second impact threshold.

In some embodiments, one or more deposition-prone regions are related to the first impact threshold; one or more non-deposition-prone regions are related to the second impact threshold. The first impact threshold and the second impact threshold in different time periods are different, and the first impact threshold and the second impact threshold corresponding to each time period are related to an average gas temperature of gas transported in the one or more pipeline regions within the time period.

The average gas temperature refers to an average value of gas temperatures of the gas transported in the one or more pipeline regions within a certain time period. The average gas temperature may be obtained based on historical gas transmission data.

In some embodiments, the average gas temperature is positively correlated with the first impact threshold and the second impact threshold corresponding to the same time period. For example, a smaller average gas temperature indicates a greater probability of hydrate condensation in the gas, and the first impact threshold and the second impact threshold corresponding to the time period are smaller.

In some embodiments of the present disclosure, regulating the first impact threshold and the second impact threshold based on the average gas temperature can ensure timely injection of the antifreeze to avoid pipeline ice blockage.

In some embodiments of the present disclosure, injecting the antifreeze into the corresponding pipeline by determining the target antifreeze injection device can efficiently and accurately inject the antifreeze in time, preventing formation of hydrates in the gas within the pipeline.

Some embodiments of the present disclosure further provide a non-transitory computer-readable storage medium, comprising computer instructions that, when read by a computer, direct the computer to implement the method according to any one of the foregoing embodiments.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. An Internet of Things (IoT) system for anti-freezing operation of a smart gas pipeline network, comprising: a smart gas company management platform, a smart gas company sensor network platform, and a smart gas equipment object platform; wherein
the smart gas company management platform includes a data center; the smart gas company management platform is in communication with the smart gas equipment object platform through the smart gas company sensor network platform; the smart gas company management platform is configured to:
obtain, from the data center, historical pigging data of one or more pipeline regions in a target gas pipeline network, and determine historical deposition data of the one or more pipeline regions based on the historical pigging data;
obtain, from the data center, historical maintenance data of the one or more pipeline regions;
generate a first impact curve of the one or more pipeline regions based on the historical deposition data and the historical maintenance data;
at each preset period:
determine a deposition impact value of the one or more pipeline regions based on current deposition data of the one or more pipeline regions and the first impact curve;
in response to the deposition impact value of the one or more pipeline regions exceeding a first preset threshold, generate an antifreeze injection parameter based on current transmission data and planned transmission data of the one or more pipeline regions; and
send the antifreeze injection parameter to the smart gas equipment object platform to control, based on the antifreeze injection parameter, one or more antifreeze injection devices within the smart gas equipment object platform to inject an antifreeze into a corresponding pipeline.

2. The IoT system according to claim 1, wherein the smart gas equipment object platform further includes a heating device disposed on a gas pipeline; the smart gas company management platform is further configured to:
determine a layout density of the one or more antifreeze injection devices of the one or more pipeline regions based on the historical pigging data and the historical maintenance data of the one or more pipeline regions;
determine a regulation region based on the layout density;
generate a heating regulation parameter based on the planned transmission data of the one or more regulation regions; and
control, based on the heating regulation parameter, the heating device disposed in the regulation region to operate to heat a pipeline in the regulation region to a target temperature.

3. The IoT system according to claim 1, further comprising a smart gas government safety supervision management platform; wherein
the smart gas company management platform is further configured to:
obtain, from the smart gas government safety supervision management platform, a pipeline structural distribution within the target gas pipeline network;
determine one or more deposition-prone regions in the one or more pipeline regions based on the pipeline structural distribution;
generate a second impact curve of the one or more deposition-prone regions based on historical transmission data and historical deposition data of the one or more deposition-prone regions; and
determine the deposition impact value of the one or more pipeline regions based on the current deposition data of the one or more pipeline regions, the first impact curve, the current transmission data, and a second deposition impact data set of the one or more deposition-prone regions.

4. The IoT system according to claim 3, wherein the smart gas equipment object platform further includes one or more monitoring devices, the smart gas company management platform is further configured to:
in response to a change of the one or more deposition-prone regions, generate a first regulation instruction and a second regulation instruction, and send the first regulation instruction and the second regulation instruction to the smart gas equipment object platform, to cause the one or more monitoring devices disposed in the one or more deposition-prone regions to perform gas data monitoring and gas data upload based on a first monitoring frequency and a first upload frequency in the first regulation instruction; and
cause one or more monitoring devices disposed in one or more non-deposition-prone regions to perform gas data monitoring and gas data upload based on a second monitoring frequency and a second upload frequency in the second regulation instruction.

5. The IoT system according to claim 3, wherein the smart gas company management platform is further configured to:
determine a blockage risk of the one or more pipeline regions through a data processing model based on the current transmission data, the planned gas transmission data, and the current deposition data of the one or more pipeline regions, and a pipeline vertical inclination angle and a pipeline bending angle of the one or more deposition-prone regions; wherein the data processing model is a machine learning model;
generate a maintenance regulation instruction based on the blockage risk of the one or more pipeline regions, and send the maintenance regulation instruction to the smart gas equipment object platform; and
control, based on the maintenance regulation instruction, an opening duration of an output valve at an antifreeze storage container of the one or more pipeline regions to store a target volume of antifreeze into a mobile storage tank, to perform allocation of pipeline maintenance materials among the one or more pipeline regions.

6. The IoT system according to claim 5, wherein the smart gas company management platform is further configured to: when training the data processing model, multiply a learning rate of the data processing model by a decay factor after reaching a preset count of trainings; wherein the preset count of trainings is determined based on a historical deposition impact value of each pipeline in the one or more pipeline regions.

7. The IoT system according to claim 1, wherein the smart gas company management platform is further configured to:
determine a target antifreeze injection device in the one or more pipeline regions based on the current transmission data and the first impact curve of the one or more pipeline regions, and the second impact curve and the planned transmission data of the one or more deposition-prone regions; and
control the target antifreeze injection device to inject the antifreeze into the corresponding pipeline based on the antifreeze injection parameter.

8. The IoT system according to claim 7, wherein the one or more deposition-prone regions are related to a first impact threshold; one or more non-deposition-prone regions are related to a second impact threshold; and
the first impact threshold and the second impact threshold in different time periods are different, and the first impact threshold and the second impact threshold corresponding to each time period are related to an average gas temperature of gas transported in the one or more pipeline regions within the time period.

9. A method for anti-freezing operation of a smart gas pipeline network, implemented by a smart gas company management platform of an Internet of Things (IoT) system for anti-freezing operation of a smart gas pipeline network, wherein the IoT system includes the smart gas company management platform, a smart gas company sensor network platform, and a smart gas equipment object platform;
the smart gas company management platform includes a data center; the smart gas company management platform is in communication with the smart gas equipment object platform through the smart gas company sensor network platform;
the method comprises:
obtaining, from the data center, historical pigging data of one or more pipeline regions in a target gas pipeline network, and determining historical deposition data of the one or more pipeline regions based on the historical pigging data;
obtaining, from the data center, historical maintenance data of the one or more pipeline regions;
generating a first impact curve of the one or more pipeline regions based on the historical deposition data and the historical maintenance data;
at each preset period:
determining a deposition impact value of the one or more pipeline regions based on current deposition data of the one or more pipeline regions and the first impact curve;
in response to the deposition impact value of the one or more pipeline regions exceeding a first preset threshold, generating an antifreeze injection parameter based on current transmission data and planned transmission data of the one or more pipeline regions; and
sending the antifreeze injection parameter to the smart gas equipment object platform to control, based on the antifreeze injection parameter, one or more antifreeze injection devices within the smart gas equipment object platform to inject an antifreeze into a corresponding pipeline.

10. The method according to claim 9, wherein the smart gas equipment object platform further includes a heating device disposed on a gas pipeline; the method further comprises:
determining a layout density of the one ormore antifreeze injection devices of the one or more pipeline regions based on the historical pigging data and the historical maintenance data of the one or more pipeline regions;
determining a regulation region based on the layout density;
generating a heating regulation parameter based on the planned transmission data of the one or more regulation regions; and
controlling, based on the heating regulation parameter, the heating device disposed in the regulation region to operate to heat a pipeline in the regulation region to a target temperature.

11. The method according to claim 9, wherein the system further includes a smart gas government safety supervision management platform;
the determining a deposition impact value of the one or more pipeline regions based on current deposition data of the one or more pipeline regions and the first impact curve includes:
obtaining, from the smart gas government safety supervision management platform, a pipeline structural distribution within the target gaspipeline network;
determining one or more deposition-prone regions in the one or more pipeline regions based on the pipeline structural distribution;
generating a second impact curve of the oneor more deposition-prone regions based on historical transmission data and historical deposition data of the one or more deposition-prone regions; and
determining the deposition impact value of the one or more pipeline regions based on the current deposition data of the one or more pipeline regions, the first impact curve, the current transmission data, and a second deposition impact data set of the one or more deposition-prone regions.

12. The method according to claim 11, wherein the smart gas equipment object platform further includes a monitoring device, and the method further comprises:
in response to a change of the one or more deposition-prone regions, generating a first regulation instruction and a second regulation instruction, and sending the first regulation instruction and the second regulation instruction to the smart gas equipment object platform, to cause the one or more monitoring devices disposed in the one or more deposition-prone regions to perform gas data monitoring and gas data upload based on a first monitoring frequency and a firstupload frequency in the first regulation instruction; and
causing the one or more monitoring devices disposed in one or more non-deposition-prone regions to perform gas data monitoring and gas data upload based on a second monitoring frequency and a secondupload frequency in the second regulation instruction.

13. The method according to claim 11, further comprising:
determining a blockage risk of the one or more pipeline regions through a data processing model based on the current transmission data, the planned gas transmission data, and the current deposition data of the one or more pipeline regions, and a pipeline vertical inclination angle and a pipeline bending angle of the one or more deposition-prone regions; wherein the data processing model is a machine learning model;
generating a maintenance regulation instruction based on the blockage risk of the one or more pipeline regions, and sending the maintenance regulation instruction to the smart gas equipment object platform; and
controlling, based on the maintenance regulation instruction, an opening duration of an output valve at an antifreeze storage container of the one or more pipeline regions to store a target volume of antifreeze into a mobile storage tank, to perform allocation of pipeline maintenance materials among the one or more pipeline regions.

14. The method according to claim 13, further comprising: when training the data processing model, multiplying a learning rate of the data processing model by a decay factor after reaching a preset count of trainings; wherein the preset count of trainings is determined based on a historical deposition impact value of each pipeline in the one or more pipeline regions.

15. The method according to claim 9, further comprising:
determining a target antifreeze injection device in the one or more pipeline regions based on the current transmission data and the first impact curve of the one or more pipeline regions, and the second impact curve and the planned transmission data of the one or more deposition-prone regions; and
controlling the target antifreeze injection device to inject the antifreeze into the corresponding pipeline based on the antifreeze injection parameter.

16. The method according to claim 9, wherein the one or more deposition-prone regions are related to a first impact threshold; the one or more non-deposition-prone regions are related to a second impact threshold; and;
the first impact threshold and the second impact threshold in different time periods are different, and the first impact threshold and the second impact threshold correspondingto each time period are related to an average gas temperature of gas transported in the one or more pipeline regions within the time period.

17. A non-transitory computer-readable storage medium, comprising computer instructions that, when read by a computer, direct the computer to implement the method for anti-freezing operation of the smart gas pipeline network according to claim 9.
